(19) United States
(12) Patent Application Publication
(10) Pub. No.: US 2005/0271336 A1
(43) Pub. Date: Dec. 8, 2005

(54) Material composition for the stable coupling of optical components

(75) Inventors: Tigran Galstian, Sainte-Foy (CA); Armen Zohrabyan, Sainte-Foy (CA); Amir Tork, Sainte-Foy (CA); Rouslan Birabassov, Quebec (CA)

Correspondence Address: DARBY & DARBY P.C., P. O. BOX 5257, NEW YORK, NY, 10150-5257, US

(73) Assignee: Photintech Inc., Sainte-Foy (CA)

(21) Appl. No.: 11/132,153

(22) Filed: May 17, 2005

Related U.S. Application Data
(60) Provisional application No. 60/571,251, filed on May 17, 2004.

(51) Int. Cl. G02B 6/255; G02B 6/26; G02B 6/38

(52) U.S. Cl. 385/95; 385/51; 385/73

(57) ABSTRACT

A material composition for optically coupling two optical components, a method for making such a coupling and the resulting device are provided. The material composition includes a first material system polymerizable by light, and a second material system having a refractive index smaller than that of the first material system after its polymerization. The second material system is miscible with the first prior to its polymerization, but repulsed by it afterwards. The material composition is injected between two optical components, such as a light source and waveguide or two waveguides, and exposed to light beams from both sides to generate a light guiding channel therebetween. The transverse refractive index profile in the coupling region is W-shaped.

### FIELD OF THE INVENTION

The present invention generally relates to optical devices for telecommunications or other applications, and more particularly concerns a material composition for coupling two optical components together, the resulting device and a method for making this device.

### BACKGROUND OF THE INVENTION

Light injection into optical waveguide, such as an optical fiber or planar waveguide, is widely used in many photonic applications ranging from medicine to telecommunications. The origin of the light to be injected may be, for example, a semiconductor chip or another waveguide. Very often, the difference of modal compositions or numerical apertures of two elements to be coupled makes it difficult to efficiently couple the light radiation, thus resulting into significant optical losses.

Traditional methods of coupling light into an optical fiber use micro-lens systems positioned between a light source or an input waveguide and the fiber. Typical examples of these types of system are shown in U.S. Pat. No. 5,215,489, entitled METHOD OF MAKING AN OPTICAL SEMICONDUCTOR MODULE, which issued on Jun. 1, 1993 to Nakamura; in Canadian patent No. 2,159,136, entitled OPTICAL FIBER ASSEMBLY, which issued on Jul. 3, 2001 to Takahashi; and in Canadian patent No 1,113,762, entitled OPTICAL COUPLER FOR CONNECTING A LIGHT SOURCE TO AN OPTICAL TRANSMISSION LINE, which issued on Dec. 8, 1981 to Balliet. Generally, light emerging from the light-source component passes through a micro-lens system and crosses several optical surfaces between media with different refractive indices, which introduces undesirable reflection losses. In addition, the required micro-optical elements, and the need for fine micro positioning of these elements, significantly decrease the performance and reliability of the device and increase its cost, particularly for small diameter components such as single mode fibers, etc.

A method for manufacturing a lens at the end of an optical fiber was described in U.S. Pat. No. 6,415,087, entitled POLISHED FUSED OPTICAL FIBER END FACE which issued on Jul. 2, 2002, to Yang et al. This technique creates a hyperbolic end face surface with an intermediate frustum region that is preferably polished prior to fusing tip. This simplifies the assembly process; however, the complexity of its fabrication limits its practical use.

A more interesting technique for coupling together two dissimilar optical elements uses the principle of self-focusing of light travelling in photopolymerizable materials. This well-known phenomenon was discovered by Askaryan in the early 1960's. The photosensitive polymerizing properties of such a material are used to create a light-guiding channel therein upon illumination of light with Gaussian form transfers intensity distribution. The refractive index n of the cured region being higher than that of the non-cured region, the light itself builds a gradient index lens and gets self-collimated along its propagation direction, thus creating a self-written channel of optical guiding.

The various curves of FIG. 1 (PRIOR ART) illustrate the variation of the refractive index profile along direction transverse to the light propagation direction. Certain material mixtures, originally having a uniform spatial distribution of the refractive index 10, may be solidified or polymerized by the exposition of light. By using for this exposition a light beam of non-uniform intensity 12, such as Gaussian profile, a corresponding non-uniform refractive index modulation 14 can be created. Such a transverse modulation created along the light propagation direction can be used to guide light and form a light-created gradient index lens channel.

FIG. 2 (PRIOR ART) schematically demonstrates an example of this principle where the light beam originates from a first optical component such as an optical fiber 16, which has a light guiding core 18. Light emerging from the fiber core 18 has an initially diverging profile 20, since the material composition has the uniform spatial distribution of refractive index 10 shown in FIG. 1. Supposing a fundamental emerging mode, the more intense central part of the light beam will gradually create the non-uniform transverse modulation of the refractive index 14 of FIG. 1 at the output of the fiber 16. Thanks to this modulation and lens-effect, the emerging light becomes self-collimated, adopting the more convergent profile 22.

These self-collimating phenomena have been widely used by many authors for mutual light trapping, including the case of optical beams emerging from two opposed optical fibers. The use of self-created polymer elements at the end of glass fibers, such as focusing and collimating tip, was described in an article entitled INTEGRATION OF POLYMER ELEMENTS AT THE END OF OPTICAL FIBERS BY FREE-RADICAL PHOTOPOLYMERIZATION, published in Synthetic metals, 124 (2001) 29-31, by Ecoffet et al. Frisken also described the use of photopolymerizable materials to create fiber uptapers in an article entitled LIGHT-INDUCED OPTICAL WAVEGUIDE UPTAPERS, Optics Letters, Vol. 18, No.13, pp. 1035-1037 (1993). In this work a UV curable epoxy is used between the two optical components to be coupled.

In another example, the article entitled QUASI-SOLITONIC BEHAVIOR OF SELF-WRITTEN WAVEGUIDES CREATED BY PHOTOPOLYMERIZATION, published in Optics Letters, Vol. 27, No.20, p. 1782, describes the experimental coupling of two optical fibers that are separated up to 1 cm distance.

Such solitonic couplers could be very useful for connecting two waveguides, which have significant difference of mode field diameters since these couplers can play the role of a tapered transition zone with adiabatic mode converting capability. This approach is even more important when two fibers made from quite different materials (for example silica and chalcogenide glasses) must be connected. In this case, the melting temperatures being very different for those two materials, traditional thermal splicing devices cannot be used to connect them and the solitonic coupler could be the best solution. Finally, this approach is much more tolerant on the spatial and angular positioning of fibers, which can significantly increase the efficiency of coupling.

However, several important problems remain to be solved in this approach. One of the most important problems is related to the fact that the light curing must be spatially non-uniform to create the gradient-index guiding channel. Following the initial intensity distribution of the polymerizing beam, the guiding channel can possess, for example, a Gaussian transverse distribution of the refractive index of the cured material, therefore high in the center and low at the borders. Such a structure can guide light with specific modal and dispersion characteristics. However, it is then absolutely necessary to preserve this spatially non-uniform refractive index distribution as stable as possible in time. Unfortunately, it is well known that the chemical reaction of polymerization will evolve in the rest of the material, and that it must be fixed somehow to avoid the channel erasure. A uniform photoexposition may polymerize the rest of the material, but it will significantly reduce the modulation depth of the refractive index n, such as illustrated by profile 14′ on FIG. 1. Unfortunately this “contrast reduction” process will continue slowly long after the formation of the channel, since no barrier, that could stop it, is present. Thus the refractive index gradient will be progressively reduced, also degrading the waveguiding properties of the channel.

A second problem to be solved is related to the fact that the light curable materials commercially available up to today are traditionally sensitized to the UV or visible light only. Significant progress was reported in U.S. Pat. No. 6,398,981, entitled PHOTOPOLYMERIZABLE COMPOSITION SENSITIVE TO LIGHT IN A GREEN TO INFRARED REGION OF THE OPTICAL SPECTRUM, which issued on Jun. 4, 2002, to Galstian et al. It should however be noted that even for this composition, sensitivity is almost negligible (for one photon excitation) beyond 900 nm. At the same time, the single mode fibers traditionally used in the telecommunication industry are multi-mode at wavelengths below 900 nm (they have cut-off wavelengths above 1300 nm). This means that the photopolymerizing light, with wavelength below 900 nm, may be guided in these fibers in multiple modes. The intensity distribution of the output fiber thus will not necessarily have a single maximum, such as for example a Gaussian form, but will rather possess multiple maxima and minima of intensity transversally to the propagation direction. This will generate multiple channels of self-trapping or filamentations, and a corresponding degradation of the coupling efficiency.

Accordingly, there is still a need for a simple and practical method for optically connecting a light between two optical components, such as a light emitting device and a waveguide structure that is both efficient and stable.

### SUMMARY OF THE INVENTION

In accordance with a first aspect of the present invention, there is provided a material composition for creating a light guiding channel between first and second optical components. The material composition includes a first material system having polymerizing properties responsive to light of a wavelength within a pre-determined wavelength range. Polymerization of this first material system creates the light guiding channel. A second material system is also provided. The second material system is miscible with the first material system prior to polymerization thereof, but substantially non-miscible with this first material system after polymerization thereof. The second material system has a refractive index smaller than the refractive index of the first material system after polymerization thereof.

In accordance with another aspect of the present invention, there is also provided a method for creating a light guiding channel between first and second optical components. This method includes the following steps:
a) bringing the optical components in close proximity and in alignment with each other;
b) providing a material composition between the optical components. This composition includes a first material system having polymerizing properties responsive to light of a wavelength within a pre-determined wavelength range. The material composition further includes a second material system miscible with the first material system prior to polymerization thereof, and substantially non-miscible with the first material system after polymerization thereof. The second material system has a refractive index smaller than the refractive index of the first material system after polymerization thereof;
c) outputting a first polymerizing light beam having a wavelength within said pre-determined wavelength range from the first optical component towards the second optical component; and
d) outputting a second polymerizing light beam having a wavelength within said pre-determined wavelength range from the second optical component towards the first optical component. The first and second polymerizing light beams generate the light guiding channel in the material composition through polymerization of the first material system.

In accordance with yet another aspect of the present invention, there is also provided an optical device including first and a second optical components in close proximity and in alignment with each other, and an optical coupler disposed between the first and second optical components. The coupler is made of a material composition including a first material system having polymerizing properties responsive to light of a wavelength within a pre-determined wavelength range, and a second material system. The second material system is miscible with the first material system prior to polymerization thereof, and substantially non-miscible with the first material system after polymerization thereof. The second material system has a refractive index smaller than the refractive index of the first material system after polymerization thereof. The coupler has a light guiding channel therethrough created by polymerization of the first material system therealong.

Advantageously, the present invention provides a specific liquid material solution containing a reactive, that is, an optically curable material and a low refractive index material that is miscible with the initial liquid solution, while being diffused (and repulsed) from the cured region during the curing process. The curing regime of the whole material system and mobility of the non-reactive material should be specifically chosen to allow them the spatial diffusion, and therefore the repulsion from cured regions. The passive (non-reactive) character of this material is preferably chosen in a way to prevent the polymerization propagation across the regions filled by this material. The waveguide created by light curing then adopt a specific “W-shaped” transverse profile of refractive index and is very stable over time.

Other features and advantages of the present invention will be better understood upon reading of preferred embodiments thereof with reference to the appended drawings.

### BRIEF DESCRIPTION OF THE DRAWINGS

FIG. 1 (PRIOR ART) is a graph showing different index refraction profiles transversally to the light propagation direction for a coupler according to prior art.

FIG. 2 (PRIOR ART) is a schematized view of the profile of a light beam outputted from an optical fiber into a coupler according to prior art.

FIGS. 3A and 3B respectively illustrate the composition and the refractive index profile of a coupler based on a material composition prior to polymerization, according to an embodiment of the present invention.

FIGS. 4A and 4B respectively illustrate the composition and the refractive index profile of a coupler based on a material composition after polymerization, according to an embodiment of the present invention.

FIG. 5 is a schematized side view of a system for making a coupler according to an embodiment of the present invention.

FIG. 6 is a micro-photography of a coupler such as shown in FIG. 5.

FIG. 7 is a schematized side view of an optical fiber provided with a mode converter according to an embodiment of the invention.

FIG. 8 is a photograph of a mode converter such as used in the embodiment of FIG. 7.

FIG. 9 is a schematized side view of a coupler controlled by an external control excitation according to another embodiment of the present invention.

FIG. 10A illustrates the distribution of the materials of the coupler of FIG. 9 before application of the external control excitation; FIG. 10B illustrates the effect of applying the external control excitation to the distribution of FIG. 10A; and FIG. 10C is a graph showing the refractive index profile for the couplers of FIGS. 10A and 10B.

FIG. 11 is a schematized side view of a system for making a coupler according to the present invention using a feedback control mechanism.

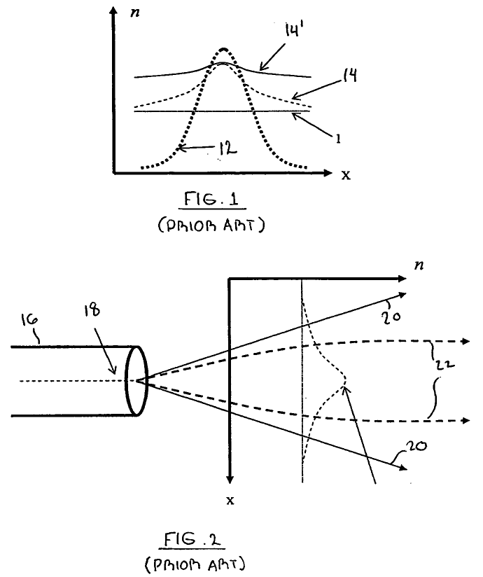

### DESCRIPTION OF PREFERRED EMBODIMENTS OF THE INVENTION

The present invention provides a material composition, a method and an apparatus for the efficient and stable coupling radiation between two optical components, particularly for components of dissimilar natures of light transmitting characteristics. For example, the present invention may be used for coupling a light-emitting source, such as vertical cavity surface emitting lasers, traditional edge emitting diode lasers, any other appropriate laser diode or an optical waveguide, to another optical waveguide such as an optical fiber or planar waveguide.

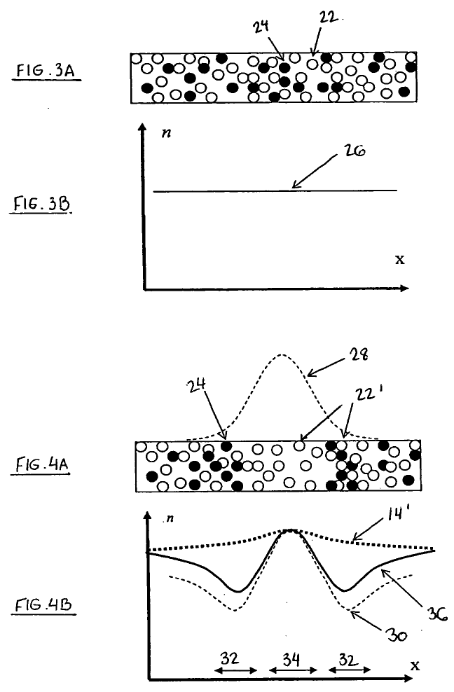

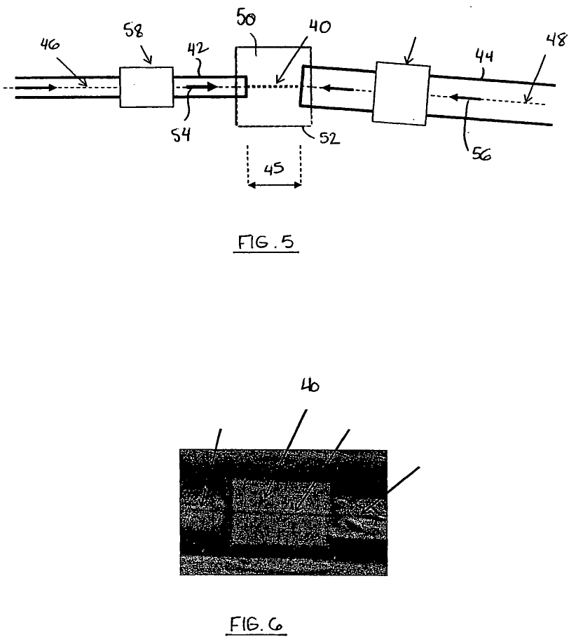

With reference to FIGS. 3A, 3B, 4A and 4B, and in accordance with a first aspect of the present invention, there is provided a material composition particularly adapted for this purpose. This material composition includes first and second material systems 22 and 24, which are initially well miscible as for example illustrated in FIG. 3A. The initial refractive index distribution 26 in the solution is therefore uniform, as shown in FIG. 3B.

The first material system 22 has polymerizing properties which are photosensitive, that is, that they are responsive to light in a predetermined wavelength range, preferably in the UV-NIR spectra. In the preferred embodiment, the first material system 22 is a complex material system including photosensitive and polymerizing compounds. The second material system 24 may be polymerizable or not. As mentioned above, the first and second material systems are selected so that they are well miscible before the polymerization of the first material system. A second requirement for this selection is the non miscibility, or at least strongly reduced miscibility of the polymer 22′ formed by the polymerization of the first material system 22, with the second material system 24. This means that a repulsion of the compounds of the second material system 24 from the polymerized zones 22′ of the first material system is obtained. This phenomenon is illustrated in FIG. 4A, applied to the creation of a light guiding channel by a polymerizing light beam having a Gaussian profile 28. It can be seen that the compounds of the second material system 24 have been pushed from the center towards the periphery of the material. This repulsion may be controlled with proper choices of polymerization rates, miscibility changes, diffusion coefficients, etc.

Another characteristic of the material solution of the invention is that the second material system 24 has a lower refractive index than the polymerized compounds of the first material system. In the case where the second material system is also polymerizable, the final refractive index after its polymerization should still be smaller than the refractive index of the polymerized first material system. The resulting non-uniform spatial distribution 30 of the refractive index across the coupling region is shown in FIG. 4B. The Gaussian-type profile obtained in the prior art is modified by the concentration of low refractive index material from the second material system 24 in the region 32 immediately surrounding the high-refractive index region 34 defining the light guiding channel. The resulting refractive index profile 30 therefore has the shape of a “W”. The particularity of the corresponding guiding channel is the fact that even after a final polymerization of the rest of the polymerizable material of the first material system outside of the central region 34, the presence of low refractive index material 24 in the region 32 will maintain a W-shaped index refraction profile 36, maintaining good guiding conditions in the channel. The prior art refractive index profile 14′ in the same conditions is represented in FIG. 4B for the comparison with the case when traditional photopolymers are used for channel creation.

The first and second material systems 22 and 24 described above may be selected among a large variety of commercially available products. In order to obtain the photosensitive properties of the first material system, the multifunctional monomers/oligomer defining the polymerizable compounds are preferably sensitized from visible to infrared region with a photoinitiating system, consisting of a sensitizer (preferably cyanine dyes), an electron donor as initiator comprising preferably heavy atom (i.e. Br—, I—, B— or Fe— containing compound), and a coinitiator substance (preferably tertiary aromatic amines). In the preferred embodiment, the second material system includes an additive compound having the necessary lower refractive index. This compound may be organic. Several non-limitative examples for the choice of these materials may be found in the following non-exhaustive list:

Monomers:
Acrylate Monomers/Oligomers—Di-Penta-Erithrithol-Penta-Acrylate (DPEPA),
2-Ethoxy-Ethoxy-Ethyl Acrylate Ester (2EEEA),
Urethane Acrylate CN975,
Dipentaerythritol Hexaacrylate,
SR297 (1,3-BUTYLENE GLYCOL DIMETHACRYLATE)
SR602, ETHOXYLATED (10) BISPHENOL A DIACRYLATE
SR355, DI-TRIMETHYLOLPROPANE TETRAACRYLATE
SR494, ETHOXYLATED (4) PENTAERYTHRITOL TETRAACRYLATE
SR399LV, LOW VISCOSITY DIPENTAERYTHRITOL PENTMCRYLATE
SR9041, PENTMCRYLATE ESTER
SR295, PENTAERYTHRITOL TETRAACRYLATE etc.
SR9035, ETHOXYLATED (15) TRIMETHYLOLPROPANE TRIACRYLATE
SR444, PENTAERYTHRITOL TRIACRYLATE
SR368, TRIS (2-HYDROXY ETHYL) ISOCYANURATE TRIACRYLATE, (all from Sartomer or Aldrich);
Fluorinated Monomers such as ZPU12-R1 series (from Zenphotonics).

Photoinitiators: cyanine dyes such as IR-140, IR-132, IR-143, IR-786 etc., Rose Bengal, Methylen blue, etc. (all from Aldrich);

Initiators (electron donors): i.e. heavy atom (Br—, B—, I— or Fe—) containing compound —CBr4, CHBr3, CHI3, etc. (all from Aldrich);

Coinitiators (electron donors): Ethyl-DiMethyl-Amino-Benzoate (EDMABzt), (from Aldrich), Benzophenone, Reactive Amine Coinitiator (CN383) (from Sartomer).

Organic Additives: Propylen Oxide (PPO), Ethylen Oxide, Ethyl Formate, Amyl acetate, etc. (all from Aldrich).

For a more precise example, the above-mentioned compounds were mixed in the following proportion (with respect to the total weight of the material composition):

| | |
|---|---|
| Multifunctional monomers/oligomer | 40-80 mass % |
| Cyanine dye | 0.02-0.2 mass % |
| Electron donor (initiator) | 1-15 mass % |
| Electron donor (coinitiator) | 1-15 mass % |
| Organic Additive | 1-30 mass % |

The obtained mixture has been successfully used for the creation of light-induced W-type waveguides.

A non-limitative example of a composition having been used to create such a waveguide is the following:

| | |
|---|---|
| IR-140 (dye) | 0.20% |
| CBr4 electron donor (initiator) | 7.15% |
| EDMABZ electron donor (coinitiator) | 4.02% |
| DPEPA (acrylic monomer) | 78.63% |
| PPO (organic compound) | 10.00% |
| TOTAL: | 100.00% |

It can be noted that, in addition to their stability, the above-mentioned W-type waveguides may have very useful optical properties, such as anomalous dispersion, a controllable fundamental mode diameter and cut-off wavelengths. More details on waveguides of this type may be found in the article entitled CHARACTERISTICS OF A DOUBLY CLAD OPTICAL FIBER WITH A LOW-INDEX INNER CLADDING published in IEEE Journal of Quantum Electronics, 1974, QE-10(12), pp. 879-887 by Shojiro Kawakami and Shingeo Nishida.

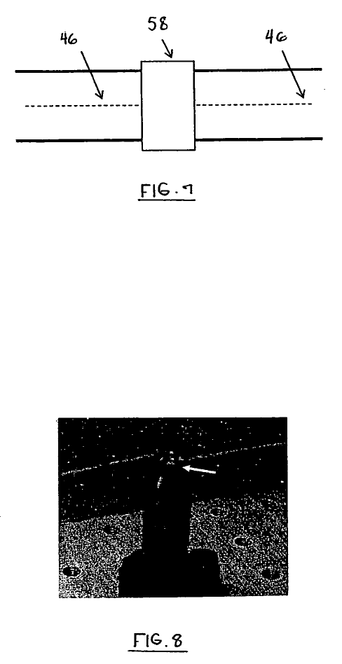

In accordance with another aspect of the present invention, and with reference to FIG. 5, there is also provided a method for creating a light guiding channel 40 between a first 42 and second 44 optical component. The term “optical component” is used herein to refer to any device either producing or transmitting radiation, such as a light source, an optical fiber or another type of waveguide. The coupled light beam may be directly generated by one of the components, or generated elsewhere and transmitted by one of the components to the other. In the non-limitative illustrated embodiment, the two optical components are both optical fibers.

The method includes a first step of bringing the two optical components 42 and 44 in proximity to each other and in alignment, so that the light beam exiting one component will propagate in the general direction of the other. It is an advantageous aspect of this method that it has a high tolerance for imprecision in this positioning, both in the longitudinal distance 45 between the extremities of the two components, and in the transverse and angular mismatches of the cores 46 and 48 of the coupled fibers 42 and 44.

A material composition 50 as described above is provided between the extremities of the two components. In practice, a hollow housing 52 is preferably provided for giving rigidity to the resulting coupler. The extremities of the optical fibers are preferably glued to this housing and the material solution injected therein.

A first polymerizing light beam 54 is outputted from the first optical component 42 in the material solution, towards the second. Similarly, a second polymerizing light beam is outputted from the second optical component 44, towards the first. The wavelength of each polymerizing light beam is selected to be within the polymerizing wavelength range for the selected materials. It is understood that each polymerizing light beam may be polychromatic, and that both light beams need not have the same spectral profile. The created channel may have reflective (and channel selective) properties if the two beams used are coherent and create reflective grating along with the principal channel formation. However, for only the channel formation, the coherence of those beams is preferably very low.

As explained above, the effect of light of a proper wavelength in the material solution according to the invention will be to generate therein a light guiding channel through polymerization of the polymerizable compounds in the first material system. The polymerization of the first material system may be directly induced by absorption of the first and second polymerizing light beams in the material composition, or indirectly induced by heat release. The self-generated light guiding paths from both optical fibers will meet along the way to create one light guiding channel coupling the two fibers. As also explained above, the transverse refractive index profile in the coupling region will be W-shaped.

In the preferred embodiment, the photopolymerizable materials in the first material system are sensitive to the UV-NIR spectra. As previously mentioned, this spectral region is below the cut-off wavelength of commonly used optical fibers for telecommunication applications, and the resulting transmitted light beam will show multiple maxima. In order to solve this issue, there are at least two possible ways: 1. use of polymerizing light with longer wavelength (e.g., 1550 nm) and material compositions that are sensitive to these wavelengths (single or multiple photo absorption to support the long wavelength induced polymerization) or 2. using a mode converter 58 in the path of first polymerizing light beam 54 propagating in the core 46 of the first optical fiber 42. The converter 58 will change the modal composition of the fiber 42 and optimize the coupling efficiency. It can, for example, simply strip (remove) the undesired modes or transfer the energy from the undesired modes to the modes that are preferred for the coupling. FIG. 7 is a schematic representation of an example of the use of the mode converter 58 to obtain a fundamental mode, having a single maximum, to be guided in the fiber core 46 with a Gaussian-shaped intensity distribution. In practice, the mode converter 58 may be embodied by a mode stripper configuration, with the optical fiber tightly wound around an axis perpendicular to the propagation direction. Such a configuration introduces high losses for higher order modes, while the fundamental mode is transmitted through it. Of course, any other appropriate device achieving the desired purpose is also considered to be within the scope of the present invention. The second optical fiber 44 may optionally also be provided with such a mode converter. Advantageously, in this embodiment the light-guiding channel created in this way may serve as a mode converter between two different fibers whose modes can be different.

It will be noted that the advantages provided by mode converters are also important in the case where the materials used may be polymerized by two (or more) photon absorption. Even in this case, the modal adaptation and control (using various methods) before recording the guiding channel will increase the coupling efficiency for desired modes.

FIG. 6 is a micro-photography showing the light induced channel 40 created using the method illustrated in FIG. 5 between two fibers 42 and 44 with cores 46 and 48, respectively.

Referring to FIG. 9, there is illustrated another aspect of the method of the present invention where the optical properties of the first and second material systems, such as their refractive index, absorption, scattering, etc., are modified by an external control excitation after creation of the light guiding channel. An external controller 60 is preferably coupled to the region of the material composition 50 to apply thereto an excitation appropriate for the control capacity of the particular materials used in the composition 50.

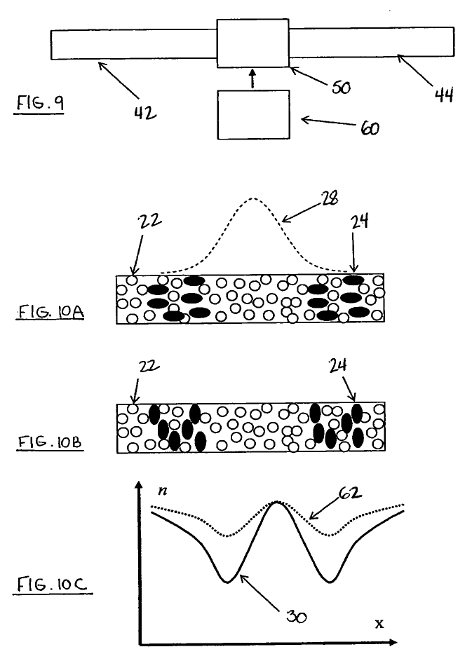

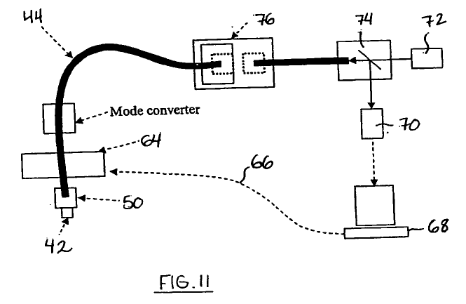

FIGS. 10A, 10B and 10C illustrate an embodiment of the invention where the controller is used to modify the transverse refractive index profile material composition. The control capacity of the composition 50 is enhanced through the use of liquid crystalline materials as the second material system 24. The crystalline material used should of course be miscible with the first material system 22 prior to polymerization thereof and have an appropriate refractive index. After the polymerization of the first material system 22 and creation of the light guiding channel, the compounds of the second material system 24 adopt a spatial distribution and orientation that provide specific optical properties, including the W-shaped transverse refractive index modulation 30 as explained above. FIG. 10A illustrates the distribution and orientation of the compounds of the second material system 24 after creation of the light guiding channel by a Gaussian light beam 28, before application of a control excitation.

FIG. 10B illustrates the effect of the application of a control excitation to the system of FIG. 10A. The excitation may be the application of an electrical voltage, heat, etc. This excitation may change the optical properties of the liquid crystalline material 24. This is schematically represented as reorientation of units 24 in FIG. 10B, that may change the profile of the refractive index modulation 62. This in turn will change the efficiency of light coupling equally for all modes or through specific mode discrimination (for example, obtaining stronger attenuation for certain guided modes). The described coupling control may be achieved also using control-sensitivity of the first material system 22, or the differential changes of both material systems 22 and 24. The mechanism of modulation can be other than molecular reorientation, for example isotropic refractive index changes, etc. It will be noted that a similar idea has already been described in U.S. Pat. No. 6,697,561, entitled VARIABLE OPTICAL ATTENUATION COLLIMATOR, delivered to He on Feb. 24, 2004. The control excitation of He is however used in a different context than the present invention.

Referring to FIG. 11, there is illustrated another aspect of the present invention where the method described above is used to couple together a light source, such as a laser diode, and an optical fiber, respectively embodying the first and second optical components 42 and 44. In this embodiment, an automated system is provided for optimizing this coupling optimization using a feedback control. Such a technique will greatly improve the efficiency of the process as compared to a manual coupling.

According to the illustrated embodiment of FIG. 11, the light emitting source 42 is first switched on and the optical fiber 44 is brought in close proximity. The material composition 50 according to the invention is injected between the two components. A detector 70 optically coupled to the optical fiber 44 continuously monitors the light intensity received therein, and therefore the strength of the coupling. To fine-tune the alignment of the optical components 42 and 44, a mechanical fiber aligner 64 is provided, which is controlled by a control feedback 66 and an optimization controller 68. The resulting feedback mechanism allows for the optimization of the coupling. Once this is achieved, a secondary light source 72 is switched on. The secondary light source 72 is relatively powerful, so as to at least partially solidify the coupling material 50 via e.g., curing or photo polymerization. The beam from this source is brought into the coupling material 50 using a light injection system 74 and a removable fiber coupler 76. The simultaneous illumination of both sources, that is, the emitting light source 42 and the secondary light source 72, creates the guiding channel. The alignment of the fiber is continually optimized by the feedback system to achieve the best coupling efficiency.

The present invention also provides an optical device including first and second optical components, and a coupler therebetween made of a material composition as described above. It will be understood that any such device resulting from one of the embodiments of a method as described above is considered to be within the scope of the present invention.

Of course, numerous modifications could be made to the embodiments described above without departing from the scope of the present invention as defined in the appended claims.

1. A method for creating a light guiding channel between first and second optical components, said method comprising the steps of:
a) bringing said optical components in close proximity and in alignment with each other;
b) providing a material composition between said optical components, said liquid comprising a first material system having polymerizing properties responsive to light of a wavelength within a pre-determined wavelength range, said liquid further comprising a second material system miscible with the first material system prior to polymerization thereof, and substantially non-miscible with said first material system after polymerization thereof, the second material system having a refractive index smaller than a refractive index of the first material system after polymerization thereof;
c) outputting a first polymerizing light beam having a wavelength within said pre-determined wavelength range from the first optical component towards the second optical component; and
d) outputting a second polymerizing light beam having a wavelength within said pre-determined wavelength range from the second optical component towards the first optical component, said first and second polymerizing light beams generating said light guiding channel in the material composition through polymerization of the first material system.

2. The method according to claim 1, wherein said first material system of the said material composition comprises:
at least one polymerizable compound; and
a photoinitiating system photo-sensitizing said compound to said polymerizing light.

3. The method according to claim 2, wherein said photoinitiating system comprises at least a sensitizer and an initiator.

4. The method according to claim 3, wherein said photoinitiating system further comprises a coinitiator

5. The method according to claim 1, wherein said second material system of the material composition comprises at least one additive having a low refractive index.

6. The method according to claim 5, wherein said additive is organic.

7. The method according to claim 1, wherein said second material system of the material composition has polymerizing properties, the refractive index of said second material system after a polymerization thereof being smaller than the refractive index of the first material system after polymerization of said first material system.

8. The method according to claim 1, wherein said pre-determined wavelength range extends from the visible to the near infra-red spectra.

9. The method according to claim 1, wherein, in step c), said polymerization of the first material system is directly induced by absorption of said first and second polymerizing light beams in the material composition.

10. The method according to claim 1, wherein, in step c), said polymerization of the first material system is indirectly induced by heat released through absorption of said first and second polymerizing light beams in the material composition.

11. The method according to claim 1, wherein step b) comprises providing a hollow housing between said optical components, and injecting side material composition within said hollow housing.

12. The method according to claim 1, wherein at least one of said first and second optical components is a waveguide.

13. The method according to claim 11, wherein at least one of said first and second optical components is an optical fiber.

14. The method according to claim 1, wherein one of said first and second optical components is a light source.

15. The method according to claim 13, wherein said optical fiber is multimode, said method further comprising an additional step before step a) of providing a mode converter in said optical fiber.

16. The method according to claim 15, wherein said mode converter removes unwanted modes from the polymerizing light propagating in said optical fiber.

17. The method according to claim 15, wherein said mode converter transfers energy from unwanted modes into wanted modes in the polymerizing light propagating in said optical fiber.

18. The method according to claim 1, further comprising an additional step e) of applying an external control excitation to said material composition for controlling optical properties of said light guiding channel.

19. The method according to claim 18, wherein said second material system of the material composition comprises at least one liquid crystalline material, and wherein the external control excitation applied in step e) is an electrical voltage.

20. The method according to claim 1, comprising an additional step between steps c) and d) of detecting an intensity of the first polymerizing light beam received in the second optical component, and iteratively adjusting the alignment of the first and second optical components to optimize said intensity.

21. A material composition for creating a light guiding channel between first and second optical components, said liquid comprising:
a first material system having polymerizing properties responsive to light of a wavelength within a predetermined wavelength range, polymerization of said first material system creating the light guiding channel; and
a second material system miscible with the first material system prior to polymerization thereof, and substantially non-miscible with said first material system after polymerization thereof;
wherein said second material system has a refractive index smaller than a refractive index of the first material system after polymerization thereof.

22. The material composition according to claim 21, wherein said pre-determined wavelength range extends from the visible to the near infra-red spectra.

23. The material composition according to claim 21, wherein said first material system comprises:
at least one polymerizable compound; and
a photoinitiating system sensitizing said compound to said light.

24. The material composition according to claim 23, wherein said second material system comprises at least one additive having a low refractive index.

25. The material composition according to claim 24, wherein said additive is organic.

26. The material composition according to claim 24, wherein said photoinitiating system comprises a sensitizer.

27. The material composition according to claim 26, wherein said sensitizer comprises a cyanide dye.

28. The material composition according to claim 26, wherein said photoinitiating system comprises an initiator.

29. The material composition according to claim 28, wherein said initiator comprises a heavy atom electron donor.

30. The material composition according to claim 28, wherein said photoinitiating system further comprises a coinitiator.

31. The material composition according to claim 30, wherein said coinitiator comprises a tertiary aromatic amine.

32. The material composition according to claim 30, wherein:
said at least one polymerizable compound is present in an amount of 40 to 60% by weight based on the total weight of said liquid;
said sensitizer is present in an amount of 0,02 to 0,2% by weight based on the total weight of said liquid;
said initiator is present in an amount of 1 to 15% by weight based on the total weight of said liquid;
said coinitiator is present in an amount of 1 to 15% by weight based on the total weight of said liquid; and
said at least one organic additive is present in an amount of 1 to 30% by weight based on the total weight of said liquid.

33. The material composition according to claim 21, wherein said first material system comprises at least one polymerizable compound selected from the group comprising:
Acrylate Monomers/Oligomers—Di-Penta-Erithrithol-Penta-Acrylate (DPEPA),
2-Ethoxy-Ethoxy-Ethyl Acrylate Ester (2EEEA),
Urethane Acrylate CN975,
Dipentaerythritol Hexaacrylate,
1,3-BUTYLENE GLYCOL DIMETHACRYLATE
ETHOXYLATED (10) BISPHENOL A DIACRYLATE
DI-TRIMETHYLOLPROPANE TETRAACRYLATE
ETHOXYLATED (4) PENTAERYTHRITOL TETRAACRYLATE
LOW VISCOSITY DIPENTAERYTHRITOL PENTMCRYLATE
PENTMCRYLATE ESTER
PENTAERYTHRITOL TETRAACRYLATE
ETHOXYLATED (15) TRIMETHYLOLPROPANE TRIACRYLATE
PENTAERYTHRITOL TRIACRYLATE
TRIS (2-HYDROXY ETHYL) ISOCYANURATE TRIACRYLATE, and
Fluorinated Monomers.

34. The material composition according to claim 33, wherein said second material system comprises at least one organic additive selected from the group comprising Propylen Oxide (PPO), Ethylen Oxide, Ethyl Formate and Amyl acetate.

35. The material composition according to claim 19, wherein said second material system has polymerizing properties also responsive to said light, the refractive index of said second material system after a polymerization thereof being smaller than the refractive index of the first material system after polymerization of said first material system.

36. An optical device comprising:
first and second optical components in close proximity and in alignment with each other; and
an optical coupler disposed between said first and second optical components, said coupler being made of a material composition comprising:
a first material system having polymerizing properties responsive to light of a wavelength within a pre-determined wavelength range; and
a second material system miscible with the first material system prior to polymerization thereof, and substantially non-miscible with said first material system after polymerization thereof, said second material system having a refractive index smaller than a refractive index of the first material system after polymerization thereof;
said coupler having a light guiding channel therethrough created by polymerization of said first material system therealong.

37. The optical device according to claim 36, further comprising a hollow housing between said optical components, said material composition being injected within said hollow housing.

38. The optical device according to claim 36, wherein at least one of said first and second optical components is a waveguide.

39. The optical device according to claim 36, wherein at least one of said first and second optical components is an optical fiber.

40. The optical device according to claim 36, wherein one of said first and second optical components is a light source.

41. The optical device according to claim 36, wherein said first material system of the said material composition comprises:
at least one polymerizable compound; and
a photoinitiating system photo-sensitizing said compound to said polymerizing light.

42. The optical device according to claim 41, wherein said photoinitiating system comprises at least a sensitizer and an initiator.

43. The optical device according to claim 42, wherein said photoinitiating system further comprises a coinitiator.

44. The optical device according to claim 36, wherein said second material system of the material composition comprises at least one organic additive.

45. The optical device according to claim 36, wherein said second material system of the material composition has polymerizing properties, the refractive index of said second material system after a polymerization thereof being smaller than the refractive index of the first material system after polymerization of said first material system.

46. The optical device according to claim 36, wherein said pre-determined wavelength range extends from the visible to the near infra-red spectra.

47. The optical device according to claim 36, further comprising an external controller for applying a control excitation to said material composition for controlling optical properties of said light guiding channel.

48. The optical device according to claim 47, wherein said second material system of the material composition comprises at least one liquid crystalline material, and wherein the external control excitation is an electrical voltage.
